(19) United States
(12) Patent Application Publication
(10) Pub. No.: US 2013/0174066 A1
(43) Pub. Date: Jul. 4, 2013

(54) USER INTERFACE SYSTEM FOR OPERATING MACHINES

(71) Applicant: Markus Felix, Richterswil (CH)

(72) Inventor: Markus Felix, Richterswil (CH)

(21) Appl. No.: 13/806,616

(22) PCT Filed: Jun. 21, 2011
(86) PCT No.: PCT/CH2011/000151

§ 371 Date: Feb. 20, 2013

(30) Foreign Application Priority Data
Jul. 2, 2010 (CH) 1089/10

(51) Int. Cl. G06F 3/048

(52) U.S. Cl. CPC G06F 3/048
USPC 715/763

(57) ABSTRACT

In order to produce a graphical user interface for operating one or more machines, a graphical symbol library having a plurality of graphical control elements is created and stored. Furthermore, a function library comprising a plurality of function designations having associated classification information is created and stored. Function designations are selected from the function library for a user interface, and graphical control elements from the graphical symbol library are associated with the function designations. The graphical control elements are grouped and arranged in the user interface on the basis of the classification information, class-specific rules, and stored design rules. The user interface is displayed on a touch-sensitive display in accordance with the size of the display and function rights of a user. An electromechanical control element is provided for inputting a control command regardless of rights.

### TECHNICAL FIELD

The present invention relates to a user interface system for operating machines. The present invention relates especially to a computer-based user interface system and a computer-implemented method for generating graphical user interfaces for operating one or more machines, especially printing machines, printed-product processing machines and installations.

### PRIOR ART

For operating machines, user interfaces having graphical operating interfaces are becoming increasingly used which are displayed on a touch-sensitive display, i.e. on a touch-sensitive screen or “touch screen” for the output and input of data and instructions. The reason for this is not lastly because such touch-sensitive displays provide for a more flexible and cost-effective adaptation than, for example, man-machine interfaces having electromechanical operating elements such as conventional keys, keyboards or moving computer mice.

The subject matter of WO 07025396 A is a graphical user interface which consists both of a touch screen and of mechanical keys and rotary switches. A method and a device for controlling sequences of one or more machines by means of an operating unit constructed as man-machine interface is disclosed. The sequences and parameters are programmed and also changed operatively by the user at the operating interface of the operating unit, screen-supported by means of input points. The operating interface is divided over two control panels. The first control panel has a relatively large screen and, apart from displaying operating states, tables, lists etc., is mainly used also for sequence programming. The second control panel serves as a central function for operative interventions. Both control panels are designed for a data exchange in both directions.

DE 112005001152 describes a method for retrieving and displaying technical data for an industrial facility. The subject matter of DE 112005001152 is a method for transferring a user interface on a mobile computer having relatively small display and input devices to a larger terminal which is connected to an industrial facility. As soon as a user who operates, e.g. a portable PDA (personal digital assistant) approaches the large screen of the industrial facility, a wireless facility in the vicinity of the large screen recognizes a wireless facility integrated in the PDA and a connection is set up. The user can subsequently mark and select the corresponding terminal. The large screen shows, e.g., a copy of the same display as on the PDA of the user. By providing a number of entities of a graphical user interface, parameters of a special machine can be rapidly retrieved and manipulated in this manner.

The subject matter of EP 1156437 A2 is a system and method for monitoring a printing production workflow. The system comprises workflow management software which monitors and facilitates the method steps of the workflow, namely the beginning of the order, the order inflow, the order handling, the printing production and the order completion. The workflow management software comprises an integrated object-oriented interface which visually represents the workflow and by means of which it is possible to intervene in the workflow. In addition, the software provides the functionality of creating, processing and changing composite documents as ordered collections of documents. The workflow management software provides for, e.g., cutting-out, copying, inserting, displacing actions on one page or on several pages of a document. This functionality is preferably achieved by means of pull-down menus, inserted dialog windows, option strips or symbols. In addition, the results of the actions are displayed in a visual representation of the document on the display of the workstation. Display windows are used for the intuitive visual representation of the work which must be performed at a workstation.

In DE 102008001665 A, methods for generating uniform user interfaces for controlling textile machines are described. Apart from basic application programs, additional application programs with additional functionalities are frequently implemented which, as a rule, are created by different programmers and have user interfaces according to different operating philosophies having different appearances. This leads to a high expenditure on training for the operators and to an increased risk of operating errors. In addition, the time expended for the operation during the use of the textile machine is increased. To avoid this, the use of an independent graphical program module is proposed in DE 102008001665 A in which display elements and display routines are stored. Thus, an additional application program can be developed largely independently of the basic application program and the operator is automatically presented with a uniform appearance with a uniform operating philosophy both in the basic application area and in the additional application area. DE 102008001665 A thus supports a manufacturer of textile machine controls in the development of user interfaces which are uniform for basic applications and their additional functions.

The operation of machines in industry, especially of machines in the printing and printed-product processing industry requires user interfaces with regard to configuration, control, monitoring, maintenance and editing and representation of business and operational information for very different business areas, machine types, functions, users and user authorizations, both at the control level comprising a number of machines connected to one another and at the level of individual machines or at the station level with parts of individual machines. As a rule, proprietary user interfaces of the manufacturers of the machines are used which, overall, leads to nonuniform operating interfaces if machines and/or stations of different manufacturers and/or machine generations are used in combination. However, efficient training, utilization, development and adaptation require graphical operating interfaces which are as uniform as possible, which are not available in the prior art at present.

Furthermore, it is demanded that the operating devices for the graphical operating interfaces can be arranged or mounted cost-effectively and on or at the respective machines or machine components in the industrial environment. In this context, restrictions in dimensions often exist since various logistical, safety-related or operative boundary conditions must be met in the industrial environment. Such boundary conditions regularly lead to the operating interfaces being limited to screen sizes of 5 to 15 inches.

### DESCRIPTION OF THE INVENTION

It is an object of the present invention to provide a computer-based user interface system for operating machines and a computer-implemented method for generating graphical user interfaces for operating one or more machines which do not have at least some disadvantages of the known systems.

The object is achieved by the features of the independent claims. Further advantageous embodiments are also obtained from the dependent claims and the description.

Initially, the expression “operating one or more machines” also includes the most varied activities for the configuration, control, monitoring, maintenance, higher-level production planning of in each case one machine, one machine part (station) and/or one installation comprising a number of machines in in each case one or more production lines, and also comprises the retrieval, editing and representation of operational, technical and economic business information.

One embodiment of the invention is characterized by the fact that for generating graphical user interfaces for operating one or more machines, a graphical symbol library having a plurality of graphical control elements is stored, that a function library having a plurality of function designations is stored to which classification information items are in each case allocated, that function designations are selected from the function library for the user interface, that graphical control elements from the graphical symbol library are allocated to the function designations, that the graphical control elements allocated to the selected function designations are grouped and arranged in the user interface on the basis of the classification information items, and that the graphical user interface is generated for representation on a display on the basis of the graphical symbol library and the determined grouping and arrangement of the graphical control elements. The creation and use of a graphical symbol library having graphical control elements and of a function library having classified function designations enables uniform user interfaces to be developed and generated both as stored program code before the use for the machine operation and dynamically during the operation of the machines.

In one variant of the embodiment, the classification information items comprise function groups, function subgroups, application identifiers, machine type identifiers, business area identifiers, product type identifiers, product identifiers, process identifiers and/or hierarchy stages, and the graphical control elements are grouped and arranged on the basis of class-specific rules.

In a further variant of the embodiment, the graphical control elements are additionally grouped and arranged in the user interface on the basis of stored design rules which comprise the number of graphical control elements represented simultaneously in the user interface, the number of graphical control elements arranged in a horizontal row, the number of graphical control elements arranged in a vertical column, the minimum size of graphical control elements, the permissible combinations of graphical control elements, the color combinations of adjacent graphical control elements, the color combinations of graphical control elements arranged in a horizontal row, and/or the color combinations of graphical control elements arranged in a vertical column.

In a further variant of the embodiment, the allocation of graphical control elements from the graphical symbol library to the function designations takes place in each case in dependence on the classification information items which are allocated to the relevant function designation.

A further embodiment of the invention is characterized by the fact that a computer-based user interface system for operating machines comprises a touch-sensitive display for representing a graphical operating interface and for accepting and outputting useful data with function commands and function parameters via the operating interface, that a communication module for exchanging the useful data with one or more of the machines, and a presentation module, inserted between machines and display, for representing the operating interface on the display in dependence on system parameters are provided. The presentation module provides for a dynamic adaptation of the presentation of user interfaces to system-specific states and conditions during the operation of the machines.

In one variant of the embodiment, the presentation module is configured for representing the operating interface on the display in dependence on a defined size of the display. The size of a display is intended to be the size of the display area (and, in the case of a touch-sensitive display, as a rule, the size of the corresponding touch-sensitive input area), that is to say the screen size, e.g. the screen diagonal or the screen height and width.

In a further variant of the embodiment, the machines have different technology platforms, and the user interface system comprises an adaptation module, inserted between technology platforms and presentation module, for the platform-independent exchange of useful data between machines and operating interface.

In a preferred variant of the embodiment, the presentation module is configured for representing the operating interface on the display in dependence on authorizations of a user, logged-in or registered, with different graphical control elements and with a different arrangement of these control elements.

In a further variant of the embodiment, the user interface system comprises an electromechanical control element for the authorization-independent input of a control command.

In one variant of the embodiment, the operating interface has a number of control elements represented as graphical symbols for a direct input of control commands, which are arranged in a permanently defined area of the display, and the operating interface has a variable area which is arranged outside the permanently defined area of the display and is provided for temporarily available control elements and for inputting and outputting useful data.

In a further variant of the embodiment, the presentation module is configured for providing, in dependence on a defined size of the display, a first part-area of the display for permanently available control elements and a second part-area of the display for temporarily available control elements.

In one variant of the embodiment, the presentation module is configured for arranging, in dependence on a defined size of the display, the second part-area of the display to be at least partially overlapping the first part-area of the display.

A further embodiment of the invention is characterized by the fact that, for generating graphical user interfaces for operating one or more machines, function designations are acquired, that hierarchy stages and graphical control elements are allocated to the function designations, that the graphical control elements are arranged in the user interface in dependence on the hierarchy stages of the allocated function designations, wherein graphical control elements of function designations having a high hierarchy stage are arranged in a permanently defined area of the user interface and graphical control elements of function designations having a low hierarchy stage are arranged in a variable area of the user interface outside the permanently defined area of the user interface, and that the graphical user interfaces are generated for representation on a display in each case with the arrangement of the graphical control elements of function designations having a high hierarchy stage in the permanently defined area of the user interface.

In one variant of the embodiment, the size of the permanently defined area of the user interface and the size of the variable area of the user interface are determined in dependence on the size of the display.

In a further variant of the embodiment, the size of the permanently defined area of the user interface and the size of the variable area of the user interface are determined in dependence on a number of authorized functions of a user.

A further embodiment of the invention is characterized by the fact that, for generating graphical user interfaces for operating one or more machines, function designations are acquired, that user identifications are acquired, that function designations are allocated to user identifications, that graphical control elements are allocated to the function designations, that user-specific arrangements of the graphical control elements are determined on the basis of the allocation of function designations to user identifications, and that the graphical user interfaces are generated for representation on a display in each case for a user on the basis of the relevant user-specific arrangement of the graphical control elements.

In one variant of the embodiment, the user-specific arrangement of the graphical control elements is determined on the basis of defined rules with color composition rules, symbol combination rules and/or design rules.

A further embodiment of the invention is characterized by the fact that a device for generating graphical user interfaces for operating one or more machines comprises a data acquisition module for accepting and storing function designations, a data memory for storing allocations of hierarchy stages and graphical control elements to the function designations and a layout module for arranging the graphical control elements in the user interface in dependence on the hierarchy stages of the associated function designations. In this context, graphical control elements of function designations having a high hierarchy stage are arranged in a permanently defined area of the user interface and graphical control elements of function designations having a low hierarchy stage are arranged in a variable area of the user interface outside the permanently defined area of the user interface. The device comprises also an interface generator for generating the graphical user interfaces for representation on a display in each case with the arrangement of the graphical control elements of function designations having a high hierarchy stage in the permanently defined area of the user interface.

In one variant of the embodiment, the layout module is configured for determining the size of the permanently defined area of the user interface and the size of the variable area of the user interface in dependence on the size of the display.

In a further variant of the embodiment, the layout module is configured for determining the size of the permanently defined area of the user interface and the size of the variable area of the user interface in dependence on a number of authorized functions of a user.

A further embodiment of the invention is characterized by the fact that a device for generating graphical user interfaces for operating one or more machines comprises a data acquisition module for accepting and storing function designations and user identifications, a first data memory for storing allocations of function designations to user identifications and a second data memory for storing allocations of graphical control elements to the function designations. The device comprises also a layout module for determining user-specific arrangements of the graphical control elements on the basis of the allocation of function designations to user identifications, and an interface generator for generating the graphical user interfaces for representation on a display in each case for a user on the basis of the relevant user-specific arrangement of the graphical control elements.

In a further variant of the embodiment, the layout module is configured for determining the user-specific arrangement on the basis of defined rules with color composition rules, symbol combination rules and/or design rules.

A further embodiment of the invention is characterized by the fact that a device for generating graphical user interfaces for operating one or more machines comprises a first data memory for storing a graphical symbol library having a plurality of graphical control elements and a second data memory for storing a function library having a plurality of function designations which are in each case allocated classification information items. The device also comprises a data acquisition module for accepting selections of function designations from the function library for the user interface and a third data memory for allocating graphical control elements from the graphical symbol library to the function designations. The device is also provided with a layout module for grouping and arranging the graphical control elements, allocated to the selected function designations, in the user interface on the basis of the classification information items and comprises an interface generator for generating the graphical user interface for representation on a display on the basis of the graphical symbol library and the determined grouping and arrangement of the graphical control elements.

In one variant of the embodiment, the layout module is configured for grouping and arranging the graphical control elements in the user interface also on the basis of stored design rules.

In a further variant of the embodiment, the device also comprises an element assignment module which is configured for allocating the graphical control elements from the graphical symbol library to the function designations in each case in dependence on the classification information items which are allocated to the relevant function designation.

A further embodiment of the invention is characterized by the fact that a device for operating one or more machines comprises a touch-sensitive display with a graphical user interface which has a number of control elements represented as graphical symbols, that the control elements are allocated to functions for which a logged-in or registered user is authorized and that the device comprises an electromechanical control element for the user-independent input of a control command.

A further embodiment of the invention is characterized by the fact that a device for operating one or more machines comprises a touch-sensitive display with a graphical user interface which has a number of control elements represented as graphical symbols, that the control elements are arranged in a permanently defined area of the display, that the graphical user interface has a variable area which is arranged outside the permanently defined area of the display and that the variable area of the display is defined in dependence on a size of the display.

### BRIEF DESCRIPTION OF THE DRAWINGS

In the text which follows, an embodiment of the present invention will be described with reference to an example. The example of the embodiment is illustrated by the following attached figures:

FIGS. 1, 1a, 1b, 1c: show block diagrams which schematically illustrate various embodiments of user interface systems having a device for operating one or more machines.

FIG. 2: shows a block diagram of a device for generating graphical user interfaces for operating one or more machines.

FIG. 3: shows a flowchart of a method for generating graphical user interfaces for operating one or more machines.

### APPROACHES FOR CARRYING OUT THE INVENTION

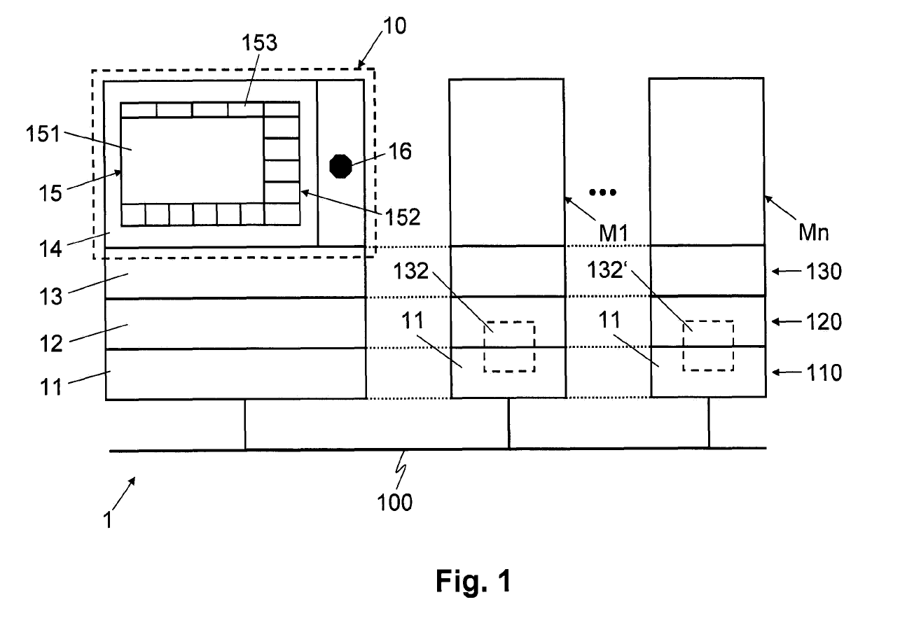

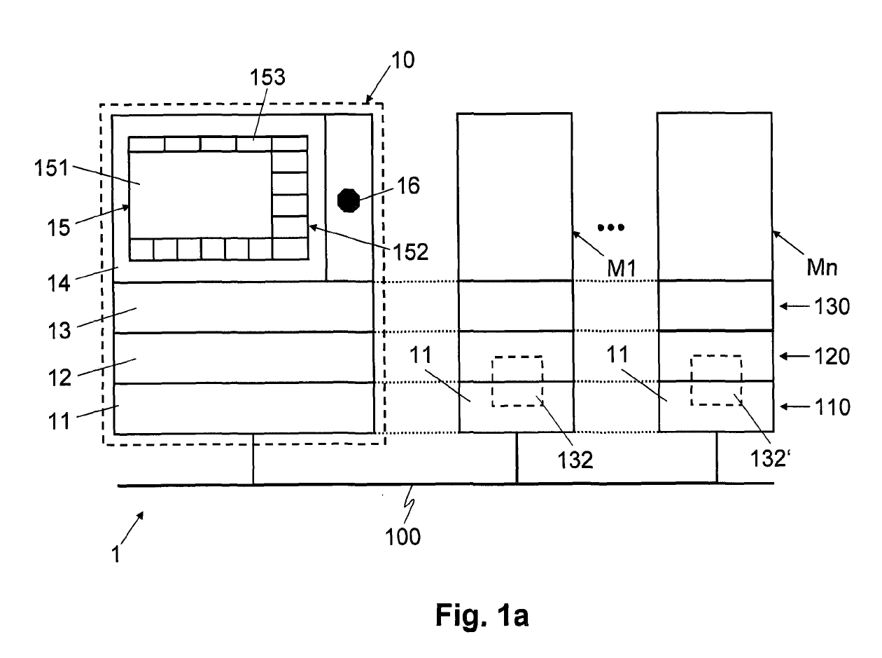

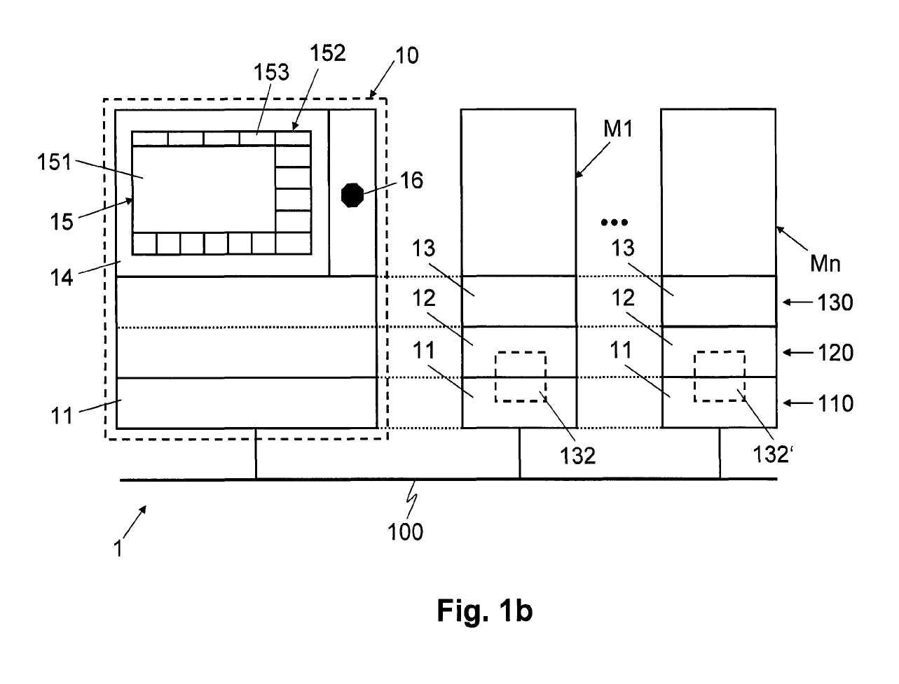

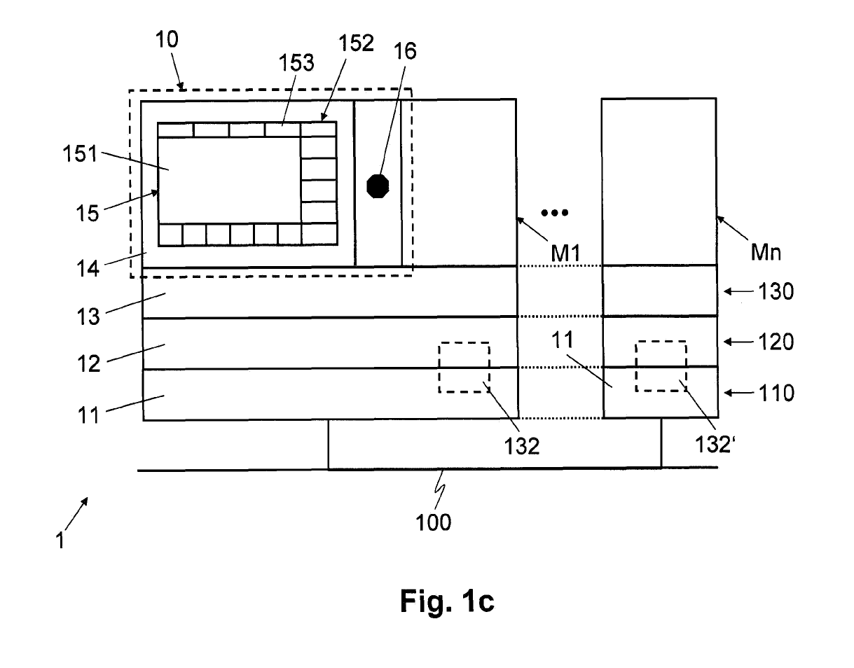

In FIGS. 1, 1a, 1b and 1c, the reference symbol 1 designates a user interface system for operating one or more machines M1 to Mn, in in each case one or more production lines, especially machines for printing systems (such as so-called rotations) and printed-product processing systems, comprising printing machines, conveyors and collection systems for collecting (in the wider sense) product collections of a number of products by carrying together, inserting or collecting (in the narrower sense), processing installations for inserting, paging, stapling, bonding, cutting, welding, and/or stacking including feeders, parcel hoists, wad feeders, winding stations and tiring machines and paper dispatch systems, digital on-demand book production system and distribution and dispatch installations (mail room). The user interface system also relates to machine units which fulfill additional functions such as, for example, attaching adhesive tags (e.g. Memostick®) or printing in the workflow and which are here also called machines. The products are, in particular, flat, flexible printed products of different thickness but also other flat products such as, for example, data media or other attachments.

The user interface system 1 comprises at least one operating device 10 having a display 14, preferably a touch-sensitive display 14, for representing a graphical operating interface designated by the reference symbol 15, or graphical user interface, respectively. The user interface system 1 comprises typically a number of operating devices 10 and displays which, depending on embodiment, are arranged as independent devices with their own housing at different distances from or directly at the machines M1, Mn (e.g. FIGS. 1a and 1b) or which are constructed together with one of the machines M1, Mn in a common housing (e.g. FIG. 1c). The displays 14 of the operating devices 10 have different display sizes which differ from one another by a multiple, for example display sizes having a screen diagonal of 5″, 10″ or 15″, but also much larger screens, preferably having a picture aspect ratio of 16:9. Touch-sensitive systems (touch screens) used can be, e.g., inductive or print-related sensor technologies which, in particular, also take into account industrial situations.

As is shown in FIGS. 1, 1a, 1b and 1c, the user interface system 1 has a number of functional modules, especially a communication module 11, an adaptation module 12 and a presentation module 13. The functional modules are designed preferably as programmed software modules, which comprise computer program code for controlling one or more processors which is stored on a computer-readable data medium connected permanently or removably to the processors.

As is shown diagrammatically in FIG. 1, the operating device 10 and the one or more machines M1, Mn are connected via a communication link 100. Above the communication link 100, a communication layer 110, an overlying technology layer 120 and a presentation layer 130 lying above that are arranged. Data and function call-ups are exchanged in each case over the layer boundaries.

The communication layer 110 comprises communication modules 11 for executing communication protocols for the data and signaling exchange between the operating device 10 and the machines M1, Mn. Depending on design, the communication link 100 is a conductorless (wireless) or conductor-connected (e.g. wired) communication interface between two computers or processors (e.g. FIGS. 1a and 1b), for example a local area network (LAN) or system bus, or a software interface executed on a common computer or processor (e.g. between the operating device 10 and the machine M1 in FIG. 1c).

The technology layer comprises different technology platforms in the machines M1, Mn and at least one adaptation module 12 arranged between display 14 and machines M1, Mn, which module is constructed on a computer or processor of the operating device 10 (e.g. FIG. 1a) and/or of one or more of the machines M1, Mn (e.g. FIGS. 1b and 1c). The different technology platforms comprise, for example, different computer operating systems, applications, development platforms, software libraries (frameworks) and/or software interfaces for applications, functions, data exchange and/or signaling. The adaptation module 12 provides for an adaptation to the different technology platforms and a platform-independent exchange of useful data between the machines M1, Mn and the operating interface 15 of the operating device 10.

The presentation layer 130 comprises at least one presentation module 13, arranged between the display 14 and machines M1, Mn, which module is constructed on a computer or processor, respectively, of the operating device 10 (e.g. FIG. 1a) and/or of one or more of the machines M1, Mn (e.g. FIGS. 1b and 1c). The presentation module 13 is configured for representing the operating interface 15 during the operation of the machines M1, Mn (in real time) in dependence on current values of system parameters which relate to current system states, conditions and configurations of the user interface system 1, of system users and/or the machines M1, Mn. The presentation module 13 is especially configured for representing the operating interface 15 during the operation of the machines M1, Mn in dependence on the display size on the display 14, for example, taking into consideration and applying defined design rules, classification information items, process flow structures and/or hierarchy stages which will be described later.

As is shown diagrammatically in FIGS. 1, 1a, 1b and 1c, the operating interface 15 or user interface 15, respectively, comprises a number of graphical control elements 153, for example selectable and activatable knobs, function knobs, rotary knobs, riders, registers, shift registers, menus, etc., with different graphical symbols and/or letterings, the letterings in each case being produced in one of several selectable and configurable languages.

In one variant of the embodiment, the operating interface comprises a permanent area 152 and a dynamic area 151. The permanent area 152 of the operating interface 15 has a permanent allocation and arrangement of graphical control elements 153 which are arranged, for example, in a defined area on the display 14. The dynamic area 151 of the operating interface 15 which, for example, is also arranged in a defined area on the display 14, in contrast, does not have a permanent but a dynamically changing allocation and arrangement of graphical control elements 153, for example in dependence on the operating state of the machines M1, Mn or functions selected by the user. Depending on the variant of the embodiment and/or application, the variable area can overlap the permanent area at least partially temporarily during a defined time. The temporary and partial overlap of the part-areas is preferably linked to the size of the display 14 and limited to relatively small display versions, for example only for 5″ displays or, to a lesser extent with a great function or control element density or in the case of extensive volumes of information being output over the operating interface, also in the case of 10″ or even 15″ displays.

In one variant of the embodiment, the presentation module 13 is configured for representing the arrangement and formation of the permanent area 152 and of the dynamic area 151 of the operating interface 15 during the operation of the machines M1, Mn (in real time) in dependence on the display size on the display 14, for example taking into consideration and applying defined design rules, classification information items, process flow structures and/or hierarchy stages which will be described later.

In the case of complex systems, the dynamic area 151 can also be formed as a so-called scrolling display. Its movement can be provided to be horizontally or vertically scrolling. Because of system security, it is important that in this context the permanent area 152 displays the security-related functions in fixed manner in order to be able to access them rapidly. If in special embodiments, system-critical operating steps are also to be executed rapidly without acknowledgement dialogs, particular operating patterns can be provided (e.g. simultaneous activating of widely spaced virtual buttons with fingers of both hands or special movements on the touch-sensitive display). This is particularly necessary within the context of industrial situations since operating errors can here lead to damage or production disruptions.

The presentation module 13 is also configured for representing the operating interface 15 on the display 14 during the operation of the machines M1, Mn (in real time) user-specifically. The presentation module 13 is especially configured for representing the operating interface 15 in dependence on the stored authorizations of a logged-in or registered user with different graphical control elements and with different arrangement of these control elements. Even the arrangement and formation of the permanent area 152 and of the dynamic area 151 of the operating interface 15 is represented user-specifically on the display 14 in one variant. In this context, defined design rules, classification information items, process flow structures and/or hierarchy stages are again taken into consideration and applied, which will be described later.

As can be seen in FIGS. 1, 1a, 1b and 1c, the operating device 10 is also provided with an electromechanical control element 16 which provides for a user- and authorization-independent and temporally undelayed input of a control command or of a control value, for example for triggering an emergency or stop function when the display 14 and/or the graphical operating interface is disrupted, for example a switch or pushbutton and/or a rotary or sliding regulator.

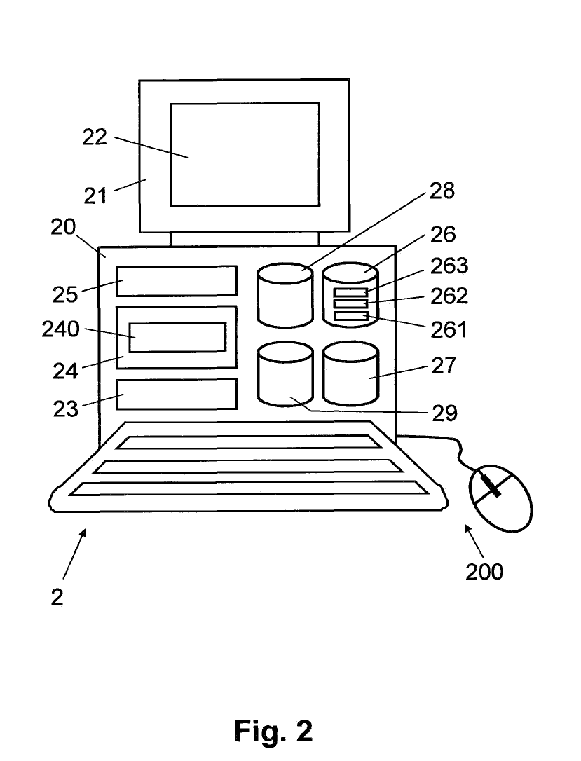

In FIG. 2, the reference symbol 2 designates a device for generating graphical user interfaces with operating interfaces 15 for operating one or more machines M1, Mn. The device 2 comprises one or more operatable computers 20 having one or more processors, a display 21 for representing a preferably graphical user interface 22 and data, and operating elements 200 for inputting data and commands.

As is shown diagrammatically in FIG. 2, the device 2 also comprises a number of functional modules, particularly a data acquisition module 23, a layout module 24, an element assignment module 240 and an interface generator 25. The functional modules are preferably constructed as programmed software modules which comprise computer program code for controlling one or more processors, which is stored on a computer-readable data medium connected permanently or removably to the device 2. The device 2 also comprises a number of data memories with a function library 26, a graphical symbol library 27, a user database 28 and a rule database 29. The function library 26 comprises data memories with function designations of defined functions, an allocation of hierarchy stages to the function designations 261, an allocation of classification information items to the function designations 262 and an allocation of graphical control elements to the function designations 263. The user database 28 comprises data memories with user profiles which comprises user identifications and associated authorizations, particularly authorizations for the various functions. In one variant of the embodiment, the function designations are also allocated process flow structures or process identifiers, respectively.

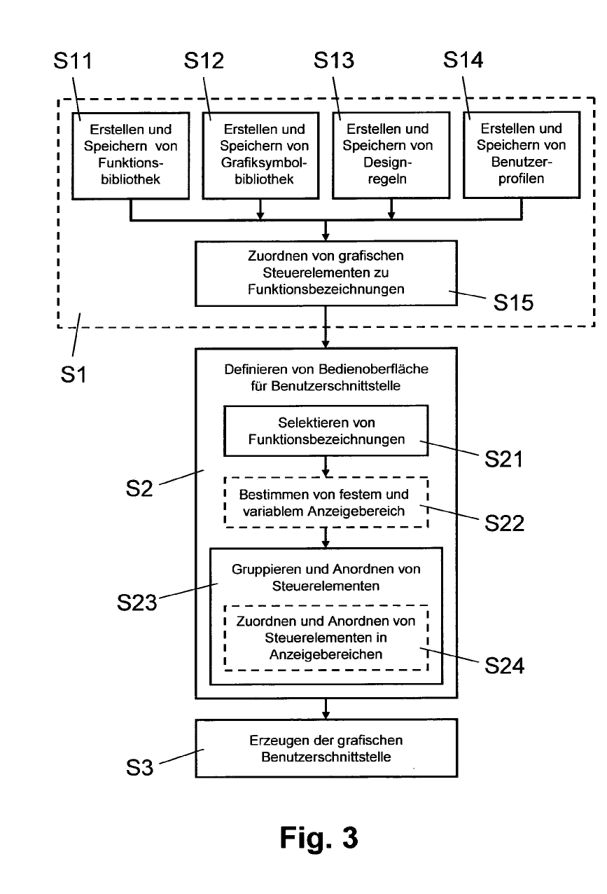

In the sections following, the functionality and possible step sequences for a method for generating graphical user interfaces for operating one or more machines are explained with reference to FIG. 3.

In FIG. 3, the reference symbol S1 designates a block with preparatory steps for the generating graphical user interfaces 15.

In step S11, a function library 26 is created and stored by means of the data acquisition module 23. The data acquisition module 23 accepts function designations of defined functions for configuring, controlling, monitoring and maintaining the machines M1, Mn via the graphical user interface 22 and stores them in the function library 26. The functions comprise, for example, read and write operations for setting or reading control and parameter values of the machines M1, Mn during a configuration and/or operating phase, and control commands for switching on, starting, stopping and switching off the machines M1, Mn. The data acquisition module 23 also enables the functions or their function designations, respectively, to be grouped and to be organized preferably hierarchically and/or in accordance with process flow structures. For this purpose, classification information items are acquired with function groups, function subgroups, application identifiers, machine type identifiers, business area identifiers, product type identifiers, product identifiers, process identifiers and hierarchy stages and are allocated to the function designations. On the basis of this, an allocation of hierarchy stages to function designations 261 and an allocation of classification information items to function designations 262 is created and stored in the function library 26. Thus, functions for various types of functions, applications, machine types, business areas, production processes/sequences and product types can be distinguished and ordered hierarchically, for example in tree and/or menu structures.

In step S12, a graphical symbol library 27 is created and stored by means of the data acquisition module 23. The data acquisition module 23 accepts via the graphical user interface 22 graphical symbols (including photographic images, e.g. images of printed products, machines M1, Mn or machine parts) for control elements and input panels/input masks in the form of file names and/or collective file names and on the basis of these creates and stores a graphical symbol library 27. The graphical symbol library 27 comprises, for example, control element designations allocated to graphical control elements with various graphical symbols (pattern, image content) in in each case different size, coloring and/or various file formats for the efficient support of various technology platforms, applications, display sizes and/or resolutions.

In step S13, a rule database 29 is created and stored by means of the data acquisition module 23. The data acquisition module 23 accepts via the graphical user interface 22 design rules with color composition rules and symbol combination rules and stores these in the rule database 29. The design rules define, for example, the number of graphical control elements simultaneously displayable in the user interface or operating interface 15, respectively, the number of graphical control elements arranged in a horizontal row, the number of graphical control elements arranged in a vertical column, the minimum size of graphical control elements, the permissible combinations of graphical control elements, the permissible and/or preferred color combinations of adjacent graphical control elements, the color combinations of graphical control elements arranged in a horizontal row and/or the color combinations of graphical control elements arranged in a vertical column. In one variant of the embodiment, the design rules are class-specific, i.e. dependent on the classification information items of the function designations, size-specific, i.e. dependent on the size of the display 14, and hierarchy-dependent, i.e. dependent on the hierarchy stage of the function designation allocated to the control element 153.

In step S14, user profiles are acquired by means of the data acquisition module 23 and stored in a user database 28. The data acquisition module 23 accepts user identifications and allocated authorizations for functions or function designations, respectively, via the graphical user interface 22 and, on the basis of these, creates corresponding user profiles with function authorizations in the user database 28.

In step S15, graphical control elements from the graphical symbol library 27 are allocated to the function designations in the function library 26. The allocation is carried out by means of the data acquisition module 23 via the graphical user interface and/or by the element assignment module 240 automatically on the basis of the classification information items which are allocated to the relevant function designations. The allocation of graphical control elements, possibly including various graphically represented input panels and input masks, to function designations 263 is stored in the function library 26.

In step S2, the operating interface 15 for the user interface 15 is defined.

In step S21, functions and possibly input panels and input masks for the operating interface 15 are defined by means of the data acquisition module 23. The data acquisition module 23 accepts selections of functions or function designations, respectively, (and possibly input panels/input masks) from the function library 26, which should be available in the operating interface 15, via the graphical user interface 22. In one variant, various language-specific translation modules are allocated to the input panels/input masks, which enable users to input voice commands in various languages.

In the optional step S22, a first part-area is defined as permanently defined display area 151 and a second part-area is defined as variable for the operating interface 15 in the display 14 by means of the data acquisition module 23. The data acquisition module 23 accepts corresponding coordinates and/or size information via the graphical user interface 22. In one variant of the embodiment, the permanent and variable display areas are determined by the layout module 24. The layout module 24 determines, for example, the size of the permanently defined area and the size of the variable area in dependence on the size of the display and/or in dependence on the (maximum) number of authorized functions of the users.

In step S23, the control elements 153 are grouped and arranged in the user interface or operating interface 15, respectively, by the layout module 24. The choice of the control elements 153 is determined by the selection of the functions in step S21 and the allocation of graphical control elements to function designations 263. The layout module 24 determines the grouping and arrangement of the graphical control elements 153 in the operating interface 15 on the basis of the stored design rules of the rule database 29 including the color composition rules and symbol combination rules and on the basis of the classification information items and/or hierarchy stages which are allocated to the function designations in the function library 26. The layout module 24 determines user-specific arrangements of the graphical control elements 153 on the basis of the allocation of function designations to user identifications in the stored user profiles of the user database 28.

In the optional step S24, the control elements 153 are grouped, allocated and arranged to the permanent and variable display areas 151, 152 of the operating interface 15 by the layout module 24. The layout module determines the grouping and arrangement of the graphical control elements 153 in the operating interface 15 in dependence on the hierarchy stages, which are allocated to the selected function designations, graphical control elements 153 of function designations having a high hierarchy stage being arranged in the permanently defined display area 151 and graphical control elements of function designations having a low hierarchy stage being arranged in the variable display area 152 of the operating interface 15.

In step S3, the interface generator 25 generates the graphical user interface or operating interface 15, respectively, for representation on the display 14 on the basis of the defined grouping and arrangement of the control elements 153.

When using portable operating devices, especially in the industrial environment, such as in the case of complex printing and print processing installations, it is particularly necessary also for safety-related requirements that the allocation of operating device 10 and machine(s) M1, Mn is not interrupted or dissolved (in disruptive instances). Within the context of step 2, it is therefore preferably possible to specify, in the permanent or variable display area 151, 152, not only operating elements of a machine M1 but additionally also a signal area or direct access for at least one second machine Mn. In this manner, it is possible to draw the attention of the user to urgent operating steps on one (or more) further machines M1 to Mn directly on the portable operating device. The user interface system according to the invention can thus be used operationally reliably particularly in the case of small screen sizes. The user is enabled by such a direct access (especially emphasized or represented function designation) preferably in a special display area to immediately switch to a different machine or a different machine unit. It is particularly in the case of complex processing installations such as, for example, in the case of a plurality of feeding devices for a collecting device that it is desirable if the operating personnel is enabled, in spite of small operating devices, to clearly operate a number or a plurality of machines M1 to Mn by means of an intelligent adaptation of the operating interface 15.

Since in the case of such small operating interfaces, the operating functions cannot be simultaneously represented for a number of or even all machines M1, Mn, the dynamic display adaptation by means of a direct access function can guarantee disruption-proof operation of complex installation areas. The (wireless or wired) communication link 100 described above between operating device 10 and machines M1 to Mn provides for the dynamic intelligent switch-over of the display 14 described. For this purpose, it is advantageous in the case of special arrangements to equip the communication layer 110 or technology layer 120, respectively, in the case of a predetermined group or in the case of all machines M1 to Mn with an additional logic module 132, 132′ which can undertake interrupt calls to one or more operating devices 10 via the communication link 100. Such an interrupt call thereupon triggers the adaptation of the operating interface 15 described before. The logic module 132, 132′ can be constructed as hardware or as software. A special area is preferably reserved for such interrupt calls on the user interface 15, but at least an area for a direct access (virtual button, warning dialog or the like).

In one variant of the embodiment, the device 2 for generating the graphical user interface or operating interface 15, respectively, is constructed as independent (stand-alone) system which, in a first phase, generates and stores executable computer code which is executed at a later time, in a second phase, on a computer or processor of the operating device 10 and/or the machines M1, Mn in order to generate the graphical user interface or operating interface 15, respectively, on the display 14. In further variants of the embodiment, at least certain functional modules, functions and/or data memories of the device 2, for example the layout module 24, the interface generator 25, the function library 26, the graphical symbol library 27, the user database 28 and the rule database 29 are formed as part of the presentation module 13 in order to define, to generate and correspondingly represent on the display 14 the operating interface 15 dynamically in real time. In particular, this provides for the dynamic adaptation of the operating interface 15 and its part-areas to different display sizes and user authorizations, taking into consideration and applying the defined design rules.

Finally, it should be noted that, although computer program code has been allocated to specific functional modules in the description and the execution of steps was represented in a particular order, the expert will understand that the computer program code can be differently structured and the order of at least certain steps can be changed without deviating from the subject matter under protection. In addition, the expert will also understand that the functional modules listed can be constructed completely or at least partially with hardware components in various variants of the embodiment.

1. A computer implemented method for generating a graphical user interface for operating one or more machines, the method comprising:
storing of a graphical symbol library having a plurality of graphical control elements;
storing of a function library having a plurality of function designations to which classification information items are in each case allocated;
selecting function designations from the function library for the user interface;
allocating graphical control elements from the graphical symbol library to the function designations;
determining a grouping and arrangement of the graphical control elements allocated to the selected function designations in the user interface on the basis of the classification information items; and
generating the graphical user interface for representation on a display on the basis of the graphical symbol library and the determined grouping and arrangement of the graphical control elements.

2. The method of claim 1, wherein the classification information items comprise at least one of: function groups, function subgroups, application identifier, machine type identifier, business area identifier, product type identifier, product identifier and hierarchy stage; and wherein the grouping and arrangement of the graphical control elements takes place on the basis of class specific rules.

3. The method of claim 1, wherein the grouping and arrangement of the graphical control elements in the user interface also takes place on the basis of stored design rules which define at least one of: a number of graphical control elements represented simultaneously in the user interface, a number of graphical control elements arranged in a horizontal row, a number of graphical control elements arranged in a vertical column, a minimum size of graphical control elements, permissible combinations of graphical control elements, color combinations of adjacent graphical control elements, color combinations of graphical control elements arranged in a horizontal row, and color combinations of graphical control elements arranged in a vertical column.

4. The method of claim 1, wherein the allocation of graphical control elements from the graphical symbol library to the function designations takes place in each case in dependence on the classification information items which are allocated to the relevant function designation.

5. The method of claim 1, further comprising:
acquiring the function designations;
allocating of hierarchy stages and graphical control elements to the function designations;
arranging the graphical control elements in the user interface in dependence on the hierarchy stages of the allocated function designations, wherein graphical control elements of function designations having a high hierarchy stage are arranged in a permanently defined area of the user interface and graphical control elements of function designations having a low hierarchy stage are arranged in a variable area of the user interface outside the permanently defined area of the user interface; and
generating of the graphical user interfaces for representation on the display in each case with the arrangement of the graphical control elements of function designations having a high hierarchy stage in the permanently defined area of the user interface.

6. The method of claim 5, wherein the size of the permanently defined area of the user interface and the size of the variable area of the user interface are determined in dependence on the size of the display.

7. The method claim 5, wherein the size of the permanently defined area of the user interface and the size of the variable area of the user interface are determined in dependence on a number of authorized functions of a user.

8. The method of claim 1, further comprising:
acquiring the function designation;
acquiring user identifications;
allocating function designations to user identifications;
allocating of graphical control elements to the function designations;
determining user specific arrangements of the graphical control elements on the basis of the allocation of function designations to user identifications; and
generating of the graphical user interfaces for representation on the display in each case for a user on the basis of the relevant user specific arrangement of the graphical control elements.

9. The method of claim 8, wherein the user specific arrangement of the graphical control elements is determined on the basis of defined rules with at least one of: color composition rules, symbol combination rules and design rules.

10. A device for generating a graphical user interface for operating one or more machines, the device comprising:
a first data memory for storing a graphical symbol library having a plurality of graphical control elements;
a second data memory for storing a function library having a plurality of function designations to which classification information items are allocated in each case;
a data acquisition module for accepting selections of function designations from the function library for the user interface;
a third data memory for allocating graphical control elements from the graphical symbol library to the function designations;
a layout module for grouping and arranging the graphical control elements, allocated to the selected function designations, in the user interface on the basis of the classification information items; and
an interface generator for generating the graphical user interface for representation on a display on the basis of the graphical symbol library and the determined grouping and arrangement of the graphical control elements.

11. The device of claim 10, wherein the classification information items comprise at least one of: function groups, function subgroups, application identifier, machine type identifier, business area identifier, product type identifier, product identifier and hierarchy stage, and wherein the grouping and arrangement of the graphical control elements takes place on the basis of class specific rules.

12. The device of claim 10, wherein the layout module is further configured for grouping and arranging the graphical control elements in the user interface also on the basis of stored design rules which define at least one of: number of graphical control elements represented simultaneously in the user interface, number of graphical control elements arranged in a horizontal row, number of graphical control elements arranged in a vertical column, permissible combinations of graphical control elements, color combinations of adjacent graphical control elements, color combinations of graphical control elements arranged in a horizontal row, and color combinations of graphical control elements arranged in a vertical column.

13. The device of claim 10, further comprising an element assignment module which is configured for allocating the graphical control elements from the graphical symbol library to the function designations in each case in dependence on the classification information items which are allocated to the relevant function designation.

14. The device of claim 10, wherein the data acquisition module is further configured for accepting and storing the function designations, wherein the device further comprises an additional data memory for storing allocations of hierarchy stages and graphical control elements to the function designations, wherein the layout module is further configured for arranging the graphical control elements in the user interface in dependence on the hierarchy stages of the allocated function designations, wherein graphical control elements of function designations having a high hierarchy stage are arranged in a permanently defined area of the user interface and graphical control elements of function designations having a low hierarchy stage are arranged in a variable area of the user interface outside the permanently defined area of the user interface, and wherein the interface generator is further configured for generating the graphical user interfaces for representation on the display in each case with the arrangement of the graphical control elements of function designations having a high hierarchy stage in the permanently defined area of the user interface.

15. The device of claim 14, wherein the layout module is further configured for determining the size of the permanently defined area of the user interface and the size of the variable area of the user interface in dependence on the size of the display.

16. The device of claim 14, wherein the layout module is further configured for determining the size of the permanently defined area of the user interface and the size of the variable area of the user interface in dependence on a number of authorized functions of a user.

17. The device of claim 10, wherein the data acquisition module is further configured for accepting and storing function designations and user identifications wherein the device further comprises additional data memories for storing allocations of function designations to user identifications and allocations of graphical control elements to the function designations, wherein the layout module is further configured for determining user specific arrangements of the graphical control elements on the basis of the allocation of function designations to user identifications, and wherein the interface generator is further configured for generating the graphical user interfaces for representation on the display in each case for a user on the basis of the relevant user specific arrangement of the graphical control elements.

18. The device of claim 17, wherein the layout module is further configured for determining the user specific arrangement on the basis of defined rules with at least one of: color composition rules, symbol combination rules and design rules.

19. A computer based user interface system for operating machines, the system comprising:
a touch sensitive display for representing a graphical operating interface and for accepting and outputting useful data with function commands and function parameters via the operating interface,
a communication module for exchanging the useful data with one or more of the machines,
a presentation module for representing the operating interface on the display in dependence on system parameters.

20. The user interface system of claim 19, wherein the presentation module is further configured for representing the operating interface on the display in dependence on a defined size of the display.

21. The user interface system of claim 19, wherein the machines have different technology platforms, and wherein the user interface system comprises an adaptation module, inserted between technology platforms and presentation module, for the platform independent exchange of useful data between machines and operating interface.

22. The user interface system of claim 19, wherein the presentation module is further configured for representing the operating interface on the display in dependence on authorizations of a logged in user with different graphical control elements and with a different arrangement of these control elements.

23. The user interface system of claim 19, further comprising an electromechanical control element for the authorization independent input of a control command.

24. The user interface system of claim 19, wherein the operating interface has a number of control elements represented as graphical symbols for a direct input of control commands, which are arranged in a permanently defined area of the display, and wherein the operating interface has a variable area which is arranged outside the permanently defined area of the display and is provided for temporarily available control elements and for inputting and outputting useful data.

25. The user interface system of claims 19, wherein the presentation module is further configured for providing, in dependence on a defined size of the display, a first part-area of the display for permanently available control elements and a second part area of the display for temporarily available control elements.

26. The user interface system of claim 25, wherein the presentation module is further configured for arranging, in dependence on a defined size of the display, the second part-area of the display to be at least partially overlapping the first part-area of the display.

27. The user interface system of claim 19, wherein the operating interface has a number of control elements represented as graphical symbols, in that the control elements are allocated to functions for which a logged in user is authorized and wherein the user interface system comprises an electromechanical control element for the user independent input of a control command.

28. The user interface system of claim 19, wherein the operating interface has a number of control elements represented as graphical symbols, wherein the control elements are arranged in a permanently defined area of the display, wherein the operating interface has a variable area which is arranged outside the permanently defined area of the display, and wherein the variable area of the display is defined in dependence on a size of the display.
